(19) United States
(12) Patent Application Publication
(10) Pub. No.: US 2010/0138474 A1
(43) Pub. Date: Jun. 3, 2010

(54) Computer-aided system and method for creating human resource competency-based tools for personnel decisions

(76) Inventors: Kevin Harkins, McLean, VA (US); Kenneth Kyle Moore, Plainfield, CT (US)

Correspondence Address: Richard Scott Toikka, 11016 Wickshire Way, Rockville, MD, 20852, US

(21) Appl. No.: 12/314,027

(22) Filed: Dec. 3, 2008

(51) Int. Cl. G06F 15/16

(52) U.S. Cl. 709/203

(57) ABSTRACT

The present invention provides a computer-aided method and system for creating an integrated interactive competencies-based personnel information system for personnel managers to use in recruitment and hiring, professional development and training and employee evaluation. The system generates a toolbox which consists of a job advertisement tool, a screening tool, an interview guide tool, a professional development tool, and an evaluation tool. All of these tools use information on the competencies required by position in a particular business establishment. The system also produces a hiring guide that takes users step-by-step through the recruitment and hiring process, including easy-to-follow directions and sample forms.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERENCE OF MATERIAL SUBMITTED ON A COMPACT DISK

Not Applicable

### BACKGROUND OF THE INVENTION

(1) Field of the Invention

The present invention is generally directed to a computer-aided system and method using the principles of competency management to allow managers to find and retain the most qualified people for jobs. More specifically the system and method creates information in a form which may be conveniently used by an end user for personnel decisions, including recruitment and hiring, job advertisement, interviews, professional development and training and performance evaluation.

(2) Description of Related Art Including Information Disclosed Under 37 CFR 1.97 and 1.98

It is generally recognized that the manner in which a company manages its human reources plays an important role in the company's profitability. Specifically, in a labor shortage economy, such is forecast for the future in the United States and Europe, the ability of businesses to attact and retain qualified workers is essential to maintaing a company's competititveness. Although this principle is well recognized, the ability of businesses to adopt personnel policies and practices has been limited by the lack of an accepted approach to personnel management based on an integrated information system. At the heart of such an information system is the concept of core competencies linked to particular jobs. These competencies, if correctly defined can drive an integrated information system which supports a company's recruitment and hiring, job advertising, job interviews, professional development and training, and employee evaluation. The advent of high speed computers and the Internet has made such an integrated competencies-based information system feasible and cost-effective.

### BRIEF SUMMARY OF THE INVENTION

An object of the present invention is to provide a computer-aided method and system for creating an integrated interactive competencies-based personnel information system for personnel managers to use in recruitment and hiring, professional development and training and employee evaluation. The system generates a toolbox which consists of a job advertisement tool, a screening tool, an interview guide tool, a professional development tool, and an evaluation tool. All of these tools use information on the competencies required by position in a particular business establishment. The system also produces a hiring guide that takes users step-by-step through the recruitment and hiring process, including easy-to-follow directions and sample forms.

The job advertisement tool consists of a template to create a targeted job advertisement based on competencies of the position. The targeted advertisement is the first step in the competency-based approach to recruiting qualified job applicants.

The screening tool consists of a comprehensive online examination that tests applicants' knowledge, skills, work ethic and ethical standards, tailored to any position in an office. The screening examination filters out unqualified candidates, significantly reducing the time required to conduct interviews, streamlines the hiring process and ensures the best candidates are selected for the job, and increases employee retention, saving on the high cost of retaining employees in that the best employee is selected for the job.

The interview guide tool creates a custom-made interview guide sheet, by position, with room for notes, and a listing of interview questions that target those competencies. The competency-based interview is the final step before hiring occurs.

The professional development tool consists of a template to create a targeted Individual Development Plan (IDP) based on the competencies of the position, complete with a listing of suggested tools and techniques to build and enhance the selected competencies. The competency theme is continued once an applicant is hired with the focus shifting to development of the employee's competencies.

The evaluation tool enables managers to quickly and effectively evaluate a worker's performance based on job competencies. The information gained by the employer is critical in assessing the employee's future with the company, including promotions and salary considerations, and assuring that the employee is using his or her competencies to make a positive contribution, and to identify weaknesses and shortfalls in performance.

### BRIEF DESCRIPTION OF THE SEVERAL VIEWS OF THE DRAWINGS

FIG. 1 illustrates the Competency Toolbox Architecture, in which the Toolbox consists of (1) a Normalized Structured Query Language (SQL) Data Store; (2) an abstracted Administrator Database spawned from the Normalized Data Store upon Admin User login; and (3) an abstracted User Database spawned from the Normalized Data Store upon Client User login. The Session Process coordinates and manages multiplier user instances via the Session Handler. The Session Handler manages unique user sessions and serves as a filter to direct access to the database from validated users. The remote user connects to the toolbox through a standard web browser.

FIG. 2 illustrates the Interactive Tool Development which facilitates the creation and delivery of tailored human resource products. Upon successful user login, the Session Handler invokes a toolbox session with the remote client and starts the Toolbox Development Process (TDP). The User Session, which persists for the duration of the tool development, interacts with the abstracted database in FIG. 1 on behalf of the user and delivers tool products to the user via the TDP as shown in FIG. 2. The tool products consist of (1) Job Advertisement Tool; (2) Screening Tool; (3) Interview Guide Tool; (4) Professional Development Tool; and (5) Performance Evaluation Tool.

### DETAILED DESCRIPTION OF THE INVENTION

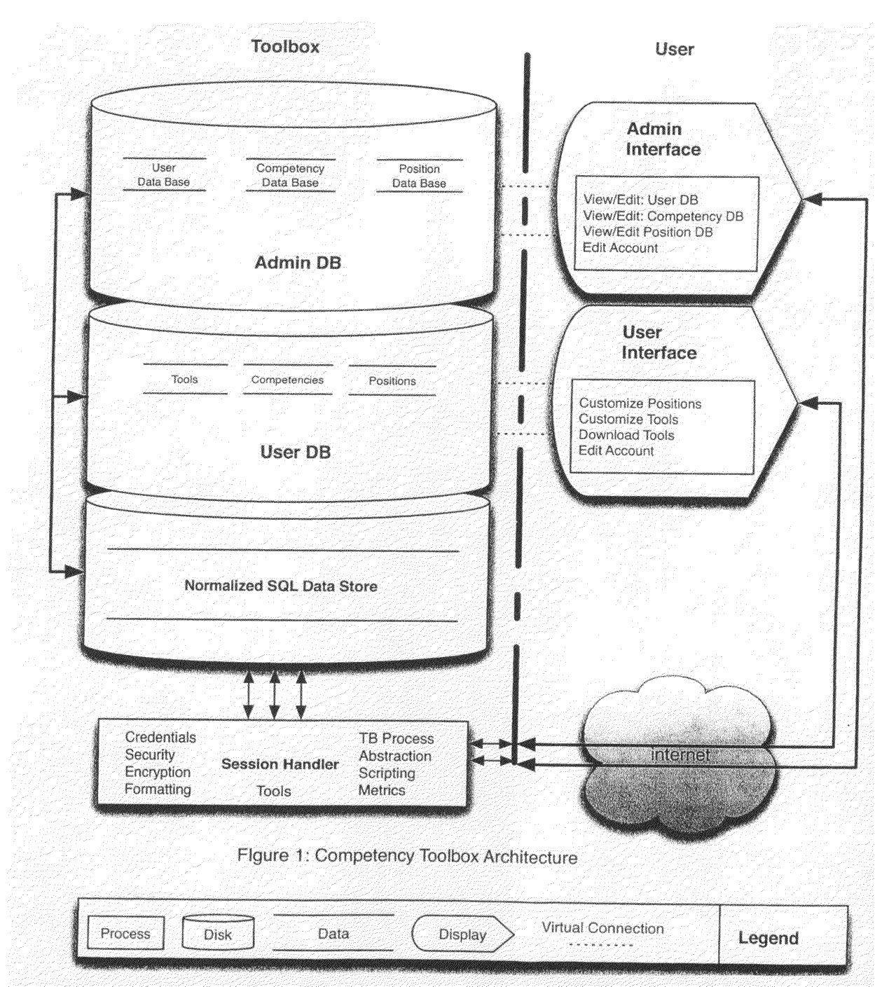

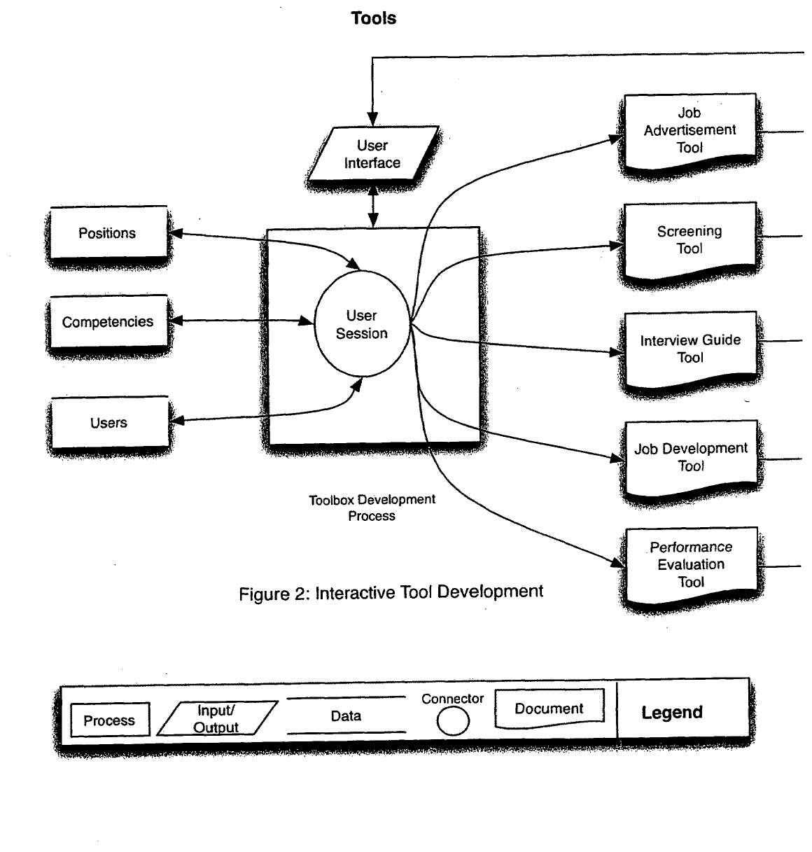

In the attached drawings, FIG. 1 illustrates the Competency Toolbox Architecture and FIG. 2, the Interactive Tool Development.

### Toolbox

The Competency Toolbox is a set of proprietary human resource tools derived from the user interaction process with the competencies and positions in the database. The tool products are as listed below:
1. The Job Advertisement Tool—a tailored job advertisement targeted for the given position based on selected competencies.
2. The Screening Tool—a comprehensive online examination that tests applicants' knowledge, skills, work ethic and ethical standards, tailored to any position in an office.
3. The Interview Guide Tool—creates a guide to the user to efficiently interview applications for the desired position based on selected competencies.
4. Professional Development Tool—a tailored plan for growth in the job position based on selected competencies.
5. Performance Evaluation Tool—an evaluation tool to assess and record job performance.

The Competency Toolbox is a web-based Server/Client network product that delivers unique competency based human resource tools to users. From a landing page on a website, users navigate to a secure login page where they can enter ID and password, and then, once authenticated, they can view a list of all positions for which they can customize compentency selections and generate tools. From this landing page, they can also request online help, contact technical support, access an interview guide and navigate from that page to a website where the screening tool is hosted.

The database driving the application contains position description information, competency definitions to suit each of the four tools generated by the toolbox based on the custom competency selections made by the user. To customize a position, the user navigates to a web page where all possible competency groups and competencies associated with a position are listed. If the user has not customized a position's competency selections yet, a default set of selections is used to set various competency selections either on or off (using radio buttons).

Users can also create their own positions, referred to as “hybrid” positions, by navigating to a page whereon all compentency groups and associated competencies are listed. Once there, users can create the new position title and description and by toggling on and off, indicate which specific compentencies to associate with the new hybrid position. Once a user has created this new position with associated competencies and saved it in the database, the new position appears on the main toolbox page in the list of positions for which tools can be generated.

When generating a particular tool, a user selects the position and tool which results in a call being made to the database retrieving the custom competency selections for that position and the comptency data specifically developed for use in that tool. The system then formats and displays the tool, which the user may print for use.

The uniqueness of this invention consists in the way in which the software takes the competencies selected by the user and creates a tool which can be used immediately in the workplace.

The following example illustrates the competencies associated with an office management position:

TABLE 1
Office Manager Competencies

| | | |
|---|---|---|
| Nr | Competency | Description |

Customer Service

| | | |
|---|---|---|
| C1 | Customer Service | [symbol] Skilled in interacting with patients, guests and visitors, both in |
| | | person and on the telephone. |
| | | [symbol] The ability to convey politeness, confidence, interest, and |
| | | professionalism, while at the same time answering questions |
| | | and collecting the required patient/customer information. |
| | | Office hours/procedures |
| | | HIPAA |
| | | Insurance |
| | | [symbol] Ability to politely and professionally enforce payment plan and |
| | | collect payments due. |
| | | [symbol] Ability to recognize the needs of others, particularly patients, |
| | | and professionally and politely provide the necessary help and |
| | | direction. |
| C3 | Supervisory Customer | [symbol] Have the maturity to be able to exercise responsibility and |
| | Service | authority to make advanced customer service related decisions |
| | | on the spot. |
| | | Waive certain fees and payments based on patient |
| | | concerns and complaints. |
| | | Override set appointment schedules to accommodate |
| | | patients where needed. |

Human Resources Management

| | | |
|---|---|---|
| H1 | Personnel Management | [symbol] Possesses comprehensive knowledge and skill in HR |
| | | management: |
| | | Advertising; interviewing and reference validation; |
| | | employee selection procedures; hiring; |
| | | Training and professional development. |
| | | Performance management and evaluation. |
| | | Rewards and recognition. |
| | | Pay and compensation (timekeeping, payroll). |
| H2 | Employee Records | [symbol] Ability to maintain employee personnel files. |
| | Maintenance | |
| H3 | New Employee | [symbol] Possess good working knowledge of all internal office practices |
| | Indoctrination | and procedures and be able to communicate those to new |
| | | employees. |
| H4 | Counseling and Conflict | [symbol] Knowledge of basic counseling techniques. |
| | Resolution | [symbol] Skill in identifying and resolving personnel problems such as |
| | | work assignments, employee relations, and morale. |
| | | [symbol] Skill in identifying and resolving performance problems such |
| | | as tardiness and rules violations. |

Office Management

| | | |
|---|---|---|
| M1 | Office Functions & | [symbol] Knowledge of office functions and procedures: |
| | Procedures | Ability to lead & provide instruction to all staff. |
| | | Staff scheduling. |
| | | Maintain office calendar; staff meeting minutes. |
| M2 | Office and Office | [symbol] Knowledge of operation & maintenance of office facility: |
| | Equipment Operation and | Ability to operate HVAC system |
| | Maintenance | Ability to operate office lighting system and security |
| | | system |
| | | Knowledge of office maintenance practices; i.e., who to |
| | | call to repair plumbing, electrical, or HVAC problems. |
| | | [symbol] Ability to operate office equipment; i.e., fax machine; copier; |
| | | etc, and knowledge of equipment maintenance procedures. |
| | | [symbol] Ability to operate office telephone system. |
| M3 | Budgeting | [symbol] Ability to develop, implement and maintain office budget: |
| | | Controls cash flow. |
| | | Make bank deposits and statement reconciliation. |
| | | Prepare and sort bills. |
| | | Maintain vendor receipts and expense files. |
| | | Tax and records preparation, sales tax and income tax. |
| M4 | Tracking | [symbol] Knowledge and understanding of inventory control: |
| | Inventories/Supplies | Maintain inventory of all office assets. |
| | | Reorders supplies, printed forms and stationery. |
| | | Stock and display pamphlets, brochures and other |
| | | educational material. |
| | | Stock and supply durable medical equipment, pillows, |
| | | devices and nutritional supplements. |
| M5 | Records Security | [symbol] Knowledge of HIPAA security guidelines and procedures. |
| M6 | Computer System Manager | [symbol] Understand very basic hardware and software installation |
| | | procedures as required by the office. |
| | | [symbol] Skill in using various office-specific computer software |
| | | systems. |
| | | [symbol] Ability to retrieve data and organize, edit and prepare various |
| | | documents and reports using advanced software applications. |
| M7 | Correspondence System | [symbol] Knowledge of correspondence procedures. |
| | | [symbol] Knowledge of filing systems. |
| | | [symbol] Excellent written communication skills. |

Personal Qualities

| | | |
|---|---|---|
| P1 | Interpersonal Relations | [symbol] Ability to foster an environment that supports diverse |
| | | individuals and perspectives, fairness, dignity, compassion, and |
| | | creativity in the workplace. |
| | | [symbol] Ability to get along with others. |
| P2 | Professionalism | [symbol] Ability to present a positive, self-confident image. |
| | | [symbol] Ability to take a proactive approach to personal and |
| | | professional development. |
| P3 | Critical Thinking/ | [symbol] Skill in problem-solving. Thinks for self. Ability to apply |
| | Common Sense | sound reasoning to work situations. |
| | | [symbol] Ability to approach events and circumstances with logic and |
| | | intelligence. |
| | | [symbol] Skillfully asks questions and seeks clarification. |
| P4 | Multitasking | [symbol] Ability to juggle more than one task at a time; to do two or |
| | | three tasks simultaneously. Ability to plan multiple events, |
| | | focus on the task at hand, use time wisely, and organize and |
| | | prioritize actions. |
| P5 | Teamwork | [symbol] Demonstrate a commitment to office and office staff. |
| | | [symbol] Knowledge of how job interrelates with other staff members' |
| | | positions and office goals. |
| | | [symbol] Ability to carry own share of the workload. |
| P6 | Ethics | [symbol] Ability to apply and maintain ethical standards of conduct. |
| | | [symbol] Ability to maintain patient confidentiality. |
| P7 | Efficiency Orientation | [symbol] Proactive. Quick to take action and quick to complete tasks. |
| | | Looks for ways to compete tasks smarter, not harder. Does not |
| | | procrastinate. Well organized. Wastes little time, effort or |
| | | motion. |
| P8 | Communication/Oral | [symbol] Comfortable speaking one-on-one and/or in group settings. |
| | Presentation Skills | Gets point across without difficulty. |
| | | [symbol] Skillful at making group presentations as necessary. |
| | | [symbol] Effective writer; written work is clear, brief, well written and |
| | | easy to understand. |
| P10 | Advanced Leadership | [symbol] Ability to direct others with tact and set clear direction. |
| | | [symbol] Ability to provide guidance and direction, and lay out work in a |
| | | well planned and organized manner. |
| | | [symbol] Ability to bring out the best in people. |
| P11 | Situational Awareness | [symbol] Awareness of the importance of the job and how it impacts |
| | | patient relations, office credibility and reputation, and, |
| | | ultimately, the financial solvency of practice. |
| P12 | Attention to Detail | [symbol] Ability to display meticulous behavior in field of expertise. |
| | | Carefully and diligently investigates, identifies and records |
| | | information, data, facts and figures relating to job. “Leaves no |
| | | stone unturned.” |
| P13 | Perseverance | [symbol] Ability to exhibit patience and withstand difficulty or resistance |
| | | when dealing with people. |
| | | [symbol] Ability to “never take no” for an answer when you believe your |
| | | position is correct and within the law. |

The Web Architecture for this system is shown in FIG. 1 and described below:

The Toolbox consists of:
1. A proprietary normalized SQL data store that hosts:
   Unique human resource competencies
   User information
   Toolbox workforce position data

The foundation of the data store is a custom database of proprietary competencies that are derived from workforce analyses for multiple business lines. This data store is relational and serves as the foundation of the user interaction with the toolbox.
2. An abstracted Admin Database is spawned as shown in FIG. 1, from the normalized data store upon. Admin User login. This database includes:
   The user database for admin editing
   The competency database for selected business lines
   Workforce position data for admin review
3. An abstracted User Database is spawned as illustrated in FIG. 1, from the normalized data store upon Client User login. This database includes:
   User Tools
   User Competencies
   User Positions

See FIG. 2 for a description of the processes that support the creation of the competency based HR tools that this database supports.
4. The Session Process coordinates and manages multiple user instances via the session handler. The session handler manages unique user sessions and serves as a filter to direct access to the database from validated users.
   a. To the user, the Session Handler manages:
      User login credentials
      Data encryption prior to delivery to the internet
      Tool production formatting and security
   b. To the server, the session handler manages:
      The user toolbox process (see FIG. 2)
      Database abstraction (Admin and User)
      User use metrics
      SQL instruction scripting for user database interaction

### User

The remote user connects to the toolbox through a standard web browser. After successful login, the session handler abstracts the appropriate user database and provides content to the user, via a “virtual” connection as illustrated in FIG. 1. The virtual connection allows for multiple parallel user sessions at the application layer of the Open Systems Interconnection (OSI) stack. The display presented to the user includes:
A user interface to interact with the elements of the toolbox
Access to the database via the session handler
The ability to customize user preferences for competencies and positions
Tool creation and use
The ability to edit account information

The Competency Toolbox features Interactive Tool Development which facilitates the creation and delivery of tailored human resource products as illustrated in FIG. 2.

### Toolbox Development Process

Upon successful user login, the Session Handler invokes a toolbox session with the remote client and starts the Toolbox Development Process (TDP). Encapsulated in the TDP is the User Session. The User Session persists for the duration of the tool development and interacts with the abstracted database, FIG. 1, on behalf of the user and delivers tool products to the user via the TDP as shown in FIG. 2. Feedback through the user interface ensures closed loop refinement of the TDP based on user competency selections.

### User Interface

The User Interface is a client browser connection to the Server. The content of the interface is a personalized Toolbox with the ability to interact with the abstracted user database, by selecting competencies, choosing positions and editing users.

### Data

Data support for Interactive Tool Development consists of queries to the Positions, Competencies and Users database via the user interface through the TDP in the context of a User Session. This data is managed by the TDP and presents properly formatted tools to the user based on specific user selections. Prior database selections persist until changes are made during the current session or in a later session.

I claim:

1: An interactive, computer-aided system and method using the principles of human resource competency management, comprising
a Server/Client network product which delivers human resource management tools to the user;
a data store containing user information, workforce position data and competency data;
an interface means for enabling a user to input user data, competency data, and position data;
an interface means for enabling an administrator to edit user data, competency data, and position data
a database engine which uses said position and competency data to generate and deliver to the user said human resource management tools.

2: The system and method of claim 1 wherein the said human resource management tools comprise (1) a job advertisement tool; (2) a screening tool; (3) an interview guide tool; (4) a job development tool; and (5) a performance evaluation tool, and said system and method also produces a hiring guide that takes users step-by-step through the recruitment and hiring process, including easy-to-follow directions and sample forms.

3: A system and method according to claims 1 or 2 in which said human resource management tools are delivered to the user via the Internet.
